(19) United States
(12) Patent Application Publication
(10) Pub. No.: US 2018/0104906 A1
(43) Pub. Date: Apr. 19, 2018

(54) A Strip Assembly Helically Windable to Form a Pipe

(71) Applicant: SEKISUI Rib Loc Australia Pty Ltd, Gepps Cross South (AU)

(72) Inventors: Steven David Gerald Harvey, Gepps Cross South (AU); Shaun Thomas Melville, Gepps Cross South (AU)

(73) Assignee: Sekisui Rib Loc Australia Pty Ltd, Gepps Cross South (AU)

(21) Appl. No.: 15/567,773

(22) PCT Filed: Apr. 18, 2016
(86) PCT No.: PCT/AU2016/000130

§ 371 Date: Oct. 19, 2017

(30) Foreign Application Priority Data
Apr. 16, 2015 (AU) 2015901367

(51) Int. Cl. B29C 65/00; B29C 53/78; B29C 65/02; B29C 65/48; F16L 9/16; F16L 13/10

(52) U.S. Cl. CPC B29C 66/4329; B29C 53/78; B29C 65/02; B29C 65/482; B29C 65/524; B29C 66/1162; B29C 66/5241; F16L 9/16; F16L 13/103; B29C 66/02241

(57) ABSTRACT

A strip assembly helically windable to form a pipe is disclosed. The strip assembly includes a pair of joined elongate strips, each strip having a strip width and a strip height and each strip including: a base; at least one longitudinal rib upstanding from the base; a pair of spaced apart longitudinal parallel edges; and an angled joining end surface. Each joining end surface has a joining width, the joining width at least 5% greater than the strip width. Also each joining end surface has a joining height, the joining height at least 10% greater than the strip height. The additional joint area provided by the angled joining end surfaces provides a significantly stronger joint.

### RELATED APPLICATIONS

The present invention claims priority under 35 U.S.C. 371 of PCT Application No. PCT/AU2016/000130 which, in turn, claims priority to Australian Patent Application No. AU 2015901367, the contents of which are incorporated by reference herein.

### TECHNICAL FIELD

The present invention relates to strips windable to form pipes.

### BACKGROUND

The applicant has developed various technologies to allow trenchless pipe rehabilitation. Some of these technologies will also find application outside trenchless pipe rehabilitation.

Typically, large spools of strip, sometimes referred to as “profile”, are wound using a winding machine into helically wound pipe. In order to maximise the efficiency of this process, it is desirable to provide high capacity spools of strip. That is, it is desirable to provide long lengths of strip, ideally on a single spool.

### SUMMARY

According to a first aspect of an embodiment of the invention, there is provided a strip assembly helically windable to form a pipe, the strip assembly including a pair of joined elongate strips, each strip when straight including:

a base lying in or adjacent to a base plane:

at least one longitudinal rib upstanding from the base;

a pair of spaced apart longitudinal parallel edges; and

a joining end surface,

wherein the joining end surfaces lie in a joining plane, the joining plane intersecting the base plane to form an intersecting line, the intersecting line defining an angle θ with respect to the parallel edges, the angle θ less than 80 degrees, and,

wherein the joining plane forms an angle β with respect to the base plane, the angle β being less than 75 degrees.

In one form, the angle θ is less than 73 degrees.

In one form, the angle β is less than 65 degrees.

In one form, the angle θ is less than 65 degrees.

In one form, the angle β is less than 55 degrees.

In one form, the angle θ is between 35 and 55 degrees.

In one form, the angle β is between 35 and 55 degrees.

In one form, the pair of joined strips are joined by an adhesive.

In one form, the adhesive is a cyanoacrylate adhesive.

In one form, each strip includes a plurality of ribs, each rib upstanding from the base.

According to a second aspect of an embodiment of the present invention, there is provided a pipe helically wound from the strip assembly according to the first aspect of the invention.

According to a third aspect of an embodiment of the invention, there is provided a strip assembly helically windable to form a pipe, the strip assembly including a pair of joined elongate strips, each strip having a strip width and a strip height and each strip including: a base;

at least one longitudinal rib upstanding from the base:

a pair of spaced apart longitudinal parallel edges; and

an angled joining end surface,

whereby each joining end surface has a joining width, the joining width at least 1.5% greater than the strip width, and

whereby each joining end surface has a joining height, the joining height at least 3.5% greater than the strip height.

In one form the joining width is at least 5% greater than the strip width.

In one form the joining height is at least 10% greater than the strip height.

In one form the joining width is at least 10% greater than the strip width.

In one form the joining height is at least 20% greater than the strip height.

According to a fourth aspect of an embodiment of the present invention, there is provided a method of joining a first strip to a second strip, each strip including: a base having first and second spaced-apart parallel longitudinal edges; and at least one longitudinal rib upstanding from the base, the method including the steps of:

(1) positioning an end portion of the first strip over an end portion of the second strip such that: the first longitudinal edge of the first strip overlaps and is substantially aligned with the first longitudinal edge of the second strip, and the second longitudinal edge of the first strip overlaps and is substantially aligned with the second longitudinal edge of the second strip;

(2) cutting the overlapping end portions of the first and second strips to produce a pair of adjacent angled joining end surfaces;

(3) treating at least one of the pair of joining end surfaces;

(4) pressing the pair of joining end surfaces against each other so as to create compression and holding the compression for a time period, the time period sufficient to create a bond,

thereby bonding the first strip to the second strip.

In one form, the method further includes the step of:

re-cutting and thereby re-forming the pair of joining end surfaces while the base of the first strip is aligned with the base of the second strip,

wherein, the re-cutting step occurring between the cutting and the treating steps.

In one form, the method further includes the step of:

re-positioning the relative positions of the joining end surface of the first strip and the joining end surface of the second strip such that they are aligned,

wherein, the re-positioning step occurs between the cutting and the re-cutting steps.

In one form, the treating step includes applying a cyanoacrylate adhesive to one of the pair of joining end surfaces.

In one form, the treating step includes heating both of the pair of joining end surfaces.

### BRIEF DESCRIPTION OF DRAWINGS

Embodiments of the present invention will be discussed with reference to the accompanying drawings wherein:

FIG. 1 shows an isometric view of a strip assembly helically windable to form a pipe;

FIG. 2A is an end view of the strip assembly of FIG. 1;

FIG. 2B is a plan view of a portion of the strip assembly of FIG. 1:

FIG. 3A is a similar view to that of FIG. 1, but includes a diagrammatic view of a joining plane to help illustrate the joining of a pair of elongate strips;

FIG. 3B is a plan view of a portion of a second of the elongate strips shown in FIG. 3A:

FIG. 3C is a side view of a portion of the second of the elongate strips shown in FIG. 3A;

FIG. 3D is an angled side view of a portion of the second of the elongate strips shown in FIG. 3A, the view angle aligned along a joining end surface

FIGS. 4A and 4B are diagrammatic side and plan views respectively that illustrate a step in joining the pair of elongate strips shown in FIG. 1;

FIGS. 5A and 5B are diagrammatic side and plan views respectively that illustrate a step in joining the pair of elongate strips shown in FIG. 1;

FIGS. 6A and 6B are diagrammatic side and plan views respectively that illustrate a step in joining the pair of elongate strips shown in FIG. 1:

FIGS. 7A and 7B are diagrammatic side and plan views respectively that illustrate a step in joining the pair of elongate strips shown in FIG. 1;

FIGS. 8A and 8B are diagrammatic side and plan views respectively that illustrate a step in joining the pair of elongate strips shown in FIG. 1;

FIGS. 9A and 9B are diagrammatic side and plan views respectively that illustrate a step in joining the pair of elongate strips shown in FIG. 1;

FIGS. 10A and 10B are diagrammatic side and plan views respectively that illustrate a step in joining the pair of elongate strips shown in FIG. 1;

FIGS. 11A and 11B are diagrammatic side and plan views respectively that illustrate a step in joining the pair of elongate strips shown in FIG. 1;

FIG. 12A is a diagrammatic perspective view of a portion of pipe wound from the strip assembly shown in FIG. 3A;

FIG. 12B is a diagrammatic perspective view of the pipe shown in FIG. 12A looking from inside the pipe;

FIG. 13A is an isometric view of a joining apparatus for joining two elongate strips together:

FIG. 13B is a close up view of the portion indicated by circle A on FIG. 13A:

FIG. 13C is a plan view of the joining apparatus shown in FIG. 13B;

FIG. 13D is a side view of the joining apparatus shown in FIG. 13B;

FIG. 13E is an end view of the joining apparatus shown in FIG. 13B;

FIG. 14A is a perspective view showing the pair of elongate strips shown in FIG. 3A before they are joined together:

FIG. 14B is an end view of one of the pair of strips shown in FIG. 14A;

FIG. 14C is a view of the end of the strip shown in FIG. 14B, viewed from a direction normal (perpendicular) to the joining plane shown in FIG. 3A, that is looking directly at the joining end surface; and

FIGS. 15A and 15B shown alternative strips that also may be joined in accordance with the invention.

### DESCRIPTION OF EMBODIMENTS

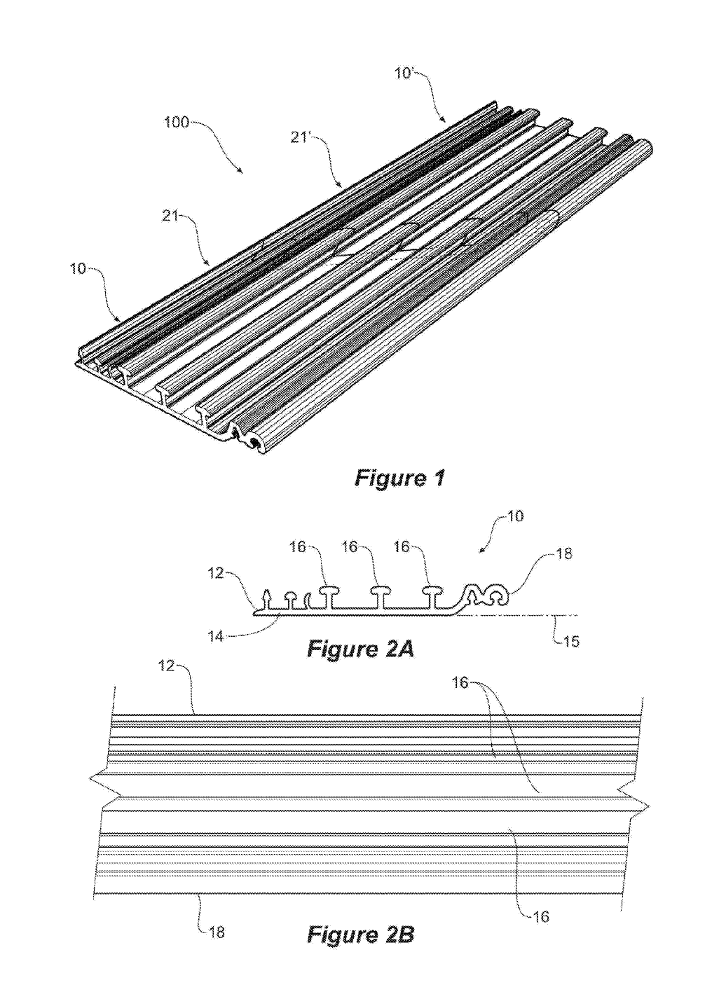

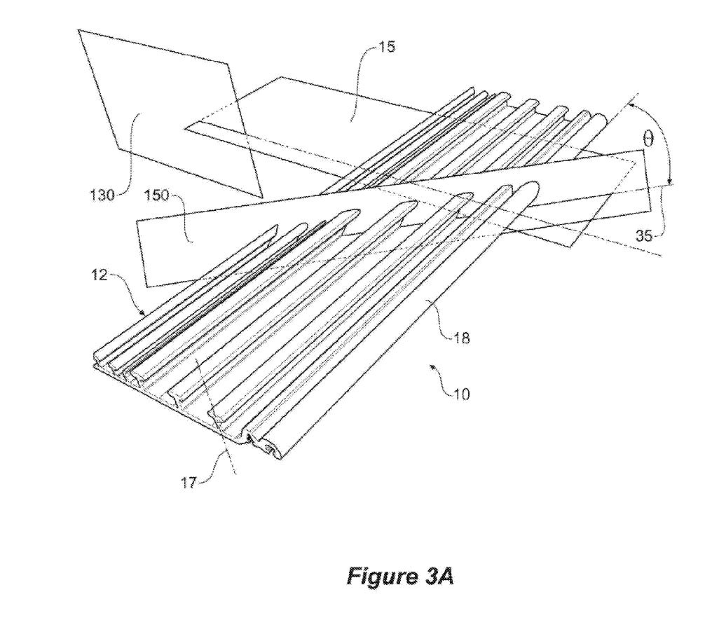

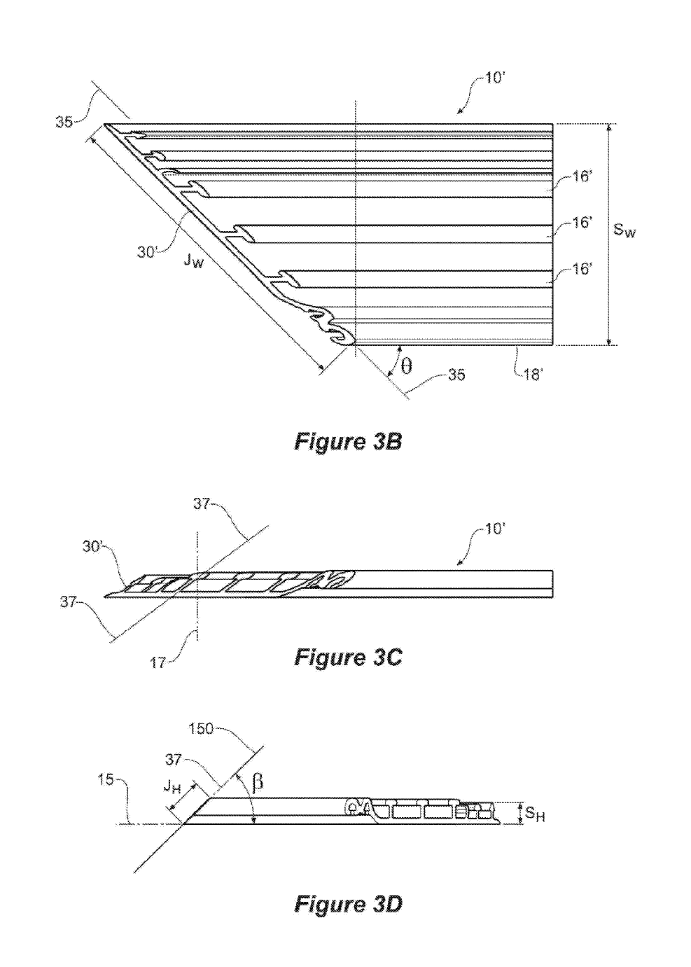

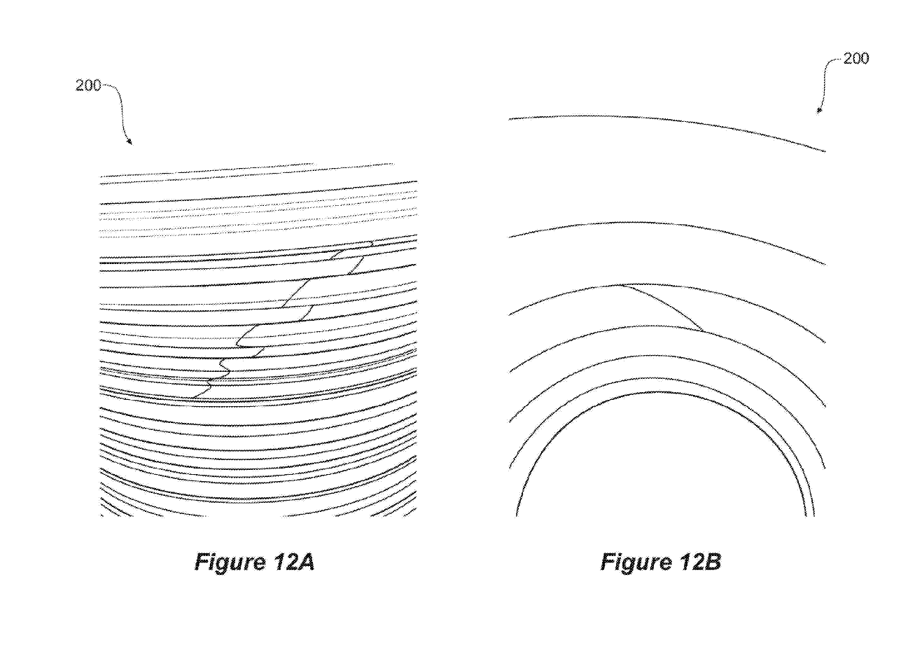

Referring now to FIG. 1, there is shown a strip assembly 100 helically windable to form a pipe 200, such as the pipe 200 illustrated in FIGS. 12A and 12B. The strip assembly 100 includes a pair of joined elongate strips 10,10′ as is shown in FIG. 1. Now referring to FIGS. 2A and 2B, it can be seen that each strip includes a base 14, at least one longitudinal rib 16 upstanding from the base 14 (in the embodiments shown in FIGS. 1 to 2A, there are three ribs 16), a pair of spaced apart longitudinal parallel edges 12,18 and a joining end surface 30. A joining end surface 30′ is illustrated in FIGS. 3B and 3C. Each rib 16 has a centreline 17 that is perpendicular to the base 14 as illustrated in FIG. 3A.

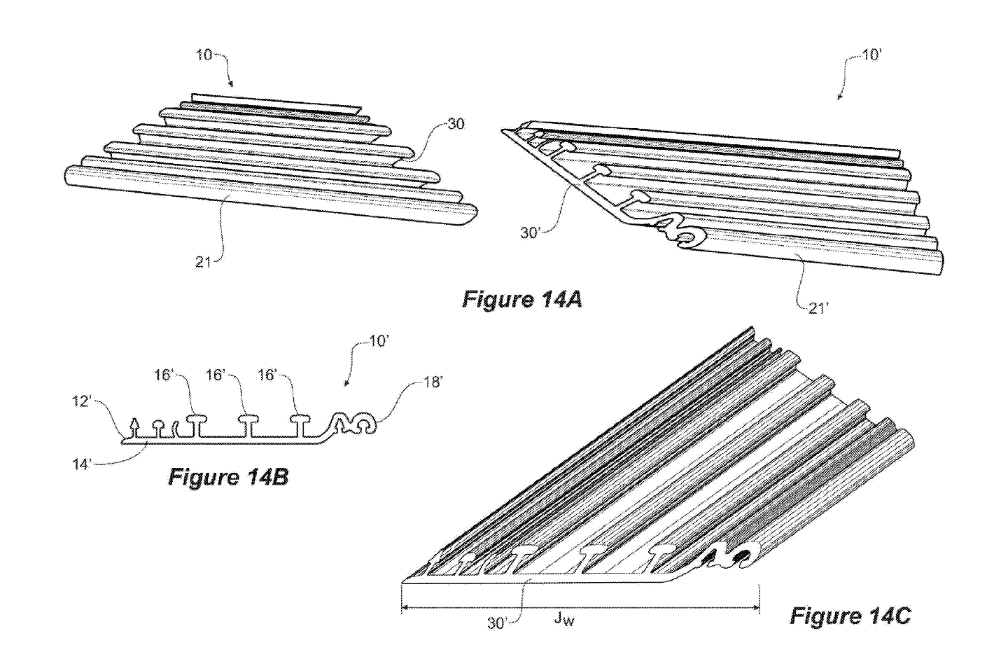

Referring now to FIG. 14A, it can be seen that the strip 10 also includes a joining end surface 30 and the strip 10′ includes the joining surface 30′. This joining end surface 30′ lies within a joining plane 150, which is illustrated in FIG. 3A. FIG. 3C shows a joining end rib surface centreline 37 that is angled with respect to the centreline 17 that is perpendicular to the base 14. The joining plane 150 intersects the parallel edges 12,18 to form an intersecting line 35, the intersecting line 35 forming an acute angle θ of less than 85 degrees with one of the pair of edges. This is most clearly illustrated in FIG. 3B, where the acute angle between the intersecting line 35 and the second edge 18 is approximately 45 degrees.

While in use the strip assembly 100 will typically be curved so as to form a helical pipe, when it is straight, the base lies in or adjacent to a base plane 15 as is shown in FIG. 3A. The joining plane 150 forms an angle β with respect to the base plane, the angle θ being less than 85 degrees as is shown in FIG. 3D. This contrasts to a typical butt joint where the joining plane would coincide with the plane 130 illustrated in FIG. 3A. Plane 130 is both perpendicular to the base plan 15 and to the edges 12, 18.

The angled joint described above and shown in FIG. 1, which may be described at an angled scarf joint, provides a larger surface area than a straight, perpendicular cut would. This is most apparent when comparing the end view of FIG. 14B with the view looking directly at the joining end surface 30′ in FIG. 14C. It also ensures that the join line is angled so that when the strip passes though pinch rollers or is curved around guide rollers the join line is progressively squeezed or otherwise stressed. This assists in making the joined strips suitable for machinery that winds strip helically to re-line pipes or conduits for instance.

The joint width, shown as J_{W} in FIG. 3B, is substantially more than the strip width, shown as S_{W} in FIG. 3B. Similarly the joint height, J_{H}, in FIG. 3D, is substantially more than the strip height, shown as S_{H} in FIG. 3D.

In one embodiment of the invention as illustrated in FIGS. 3A to 3D, the joining end surfaces 30, 30′ have twice the surface area than would be achieve by a simple butt joint. This is because the intersecting line 35 is angled at an angle θ of 45 degrees (rather than 90 degrees) with respect to the parallel edges and, the joining plane 150 forms an angle β of 45 degrees (rather than 90 degrees) with respect to the base plane. This can be calculated as follows:

J_{W}/S_{W}=1/sin θ−1/sin 45°=1/0.7071=1.414 and Increase in joint width:

J_{H}/S_{H}=1/sin β=1/sin 45°=1/0.7071=1.414 Increase in joint height:

Then, the increase in joint area is increased by J_{W}/S_{W}×J_{H}/S_{H}=1.414′=2, that is, doubled.

In another embodiment of the invention similar to that illustrated in FIGS. 3A to 3D, the joining end surfaces 30, 30′ have four times the surface area than would be achieve by a simple butt joint. This is because the intersecting line 35 is angled at an angle θ of 30 degrees (rather than 90 degrees) with respect to the parallel edges and, the joining plane 150 forms an angle β of 30 degrees (rather than 90 degrees) with respect to the base plane. This can be calculated as follows:

J_{W}/S_{W}=1/sin θ=1/sin 30°=1/0.5=2 and Increase in joint width:

J_{H}/S_{H}=1/sin β=1/sin 30°=1/0.5=2 Increase in joint height:

Then, the increase in joint area is increased by J_{W}/S_{W}×J_{H}/S_{H}=22=4, that is, quadrupled.

The additional joint area provides a significantly stronger joint.

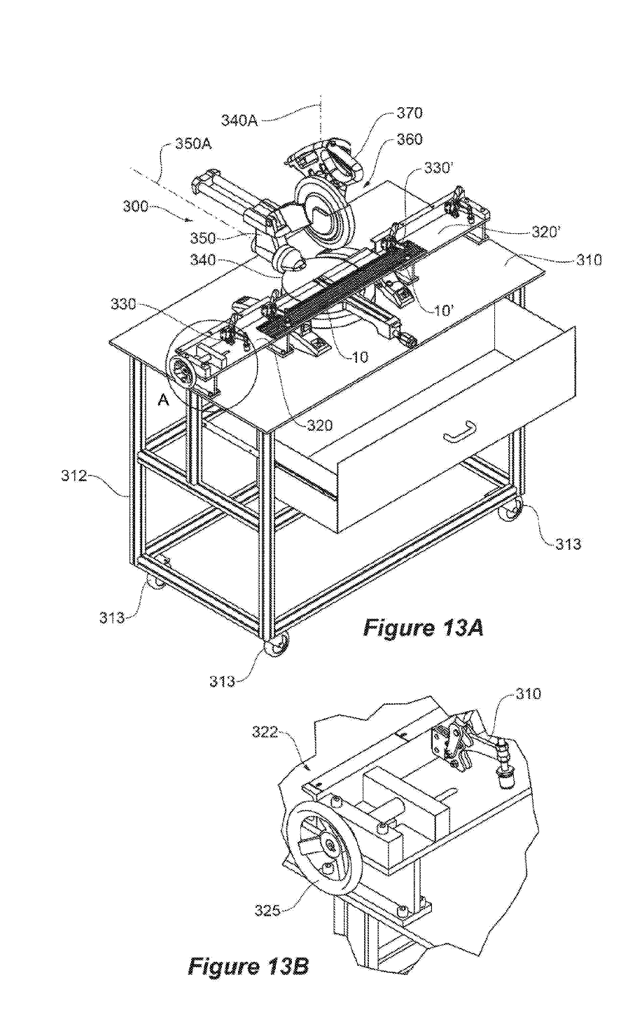

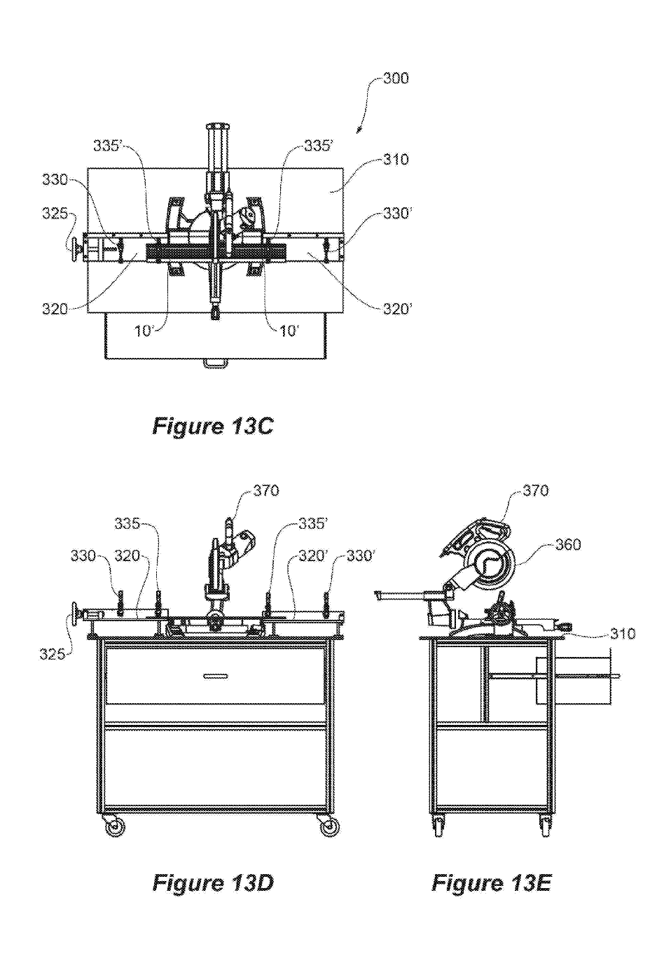

Referring now to FIGS. 13A and 13B, a joining apparatus 300 for joining two strips to form a strip assembly 100 is shown. The joining apparatus 300 includes a bench top 310 supported by a frame 312 sitting on wheels 313. The wheels 313 allow the joining apparatus to be moved easily. The joining apparatus 300 also includes strip support surfaces 320, 320′. The strip support surfaces sit above the bench top 310.

The strip support surface 320 is connected to a floating support surface adjusting mechanism 322 which allows support surface 320 to “float” or move with respect to support surface 320′ and the bench top 310. The floating support surface adjusting mechanism 322 includes a hand wheel 325 most clearly shown in the enlarged view of FIG. 13B. The hand wheel 325 is used to laterally move the strip support surface 320 away from and towards the fixed strip support surface 320′.

The bench top 310 also supports a tilting head saw 360. The saw 360 has a handle 370. The saw 360 is mounted on a rotating saw arm 350, which rotates about a saw arm axis 350a. The rotating saw arm 350 is mounted to a rotating saw base 340, which rotates about a saw base axis 340a. In this way, the saw can be rotated to create angled mitre cuts, or scarf joints.

FIG. 13C is a plan view of the joining apparatus 300 and FIGS. 13B and 13E are side view and end views respectively.

A pipe can be helically wound from the strip assembly 100 as described above to form a pipe, such as the pipe illustrated in FIGS. 12A and 12B. The ability to create the strip assembly 100 from two or more strips 10 and 10′ allows large spools of strip to be created. By providing long lengths of strip on a single spool, the efficiency of the on-site winding process can be significantly improved.

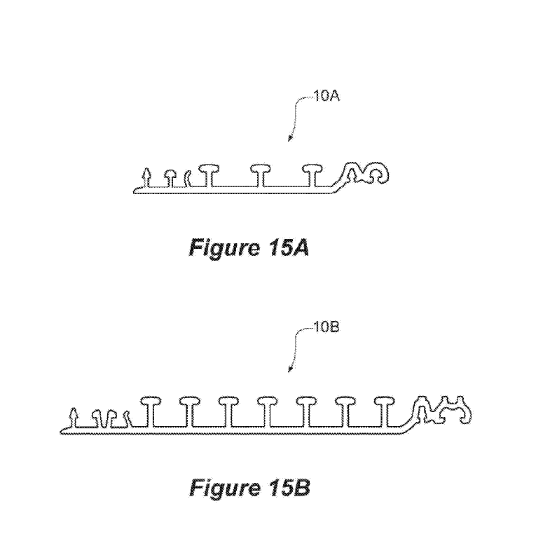

FIGS. 15A and 15B shown alternative strips 10A and 10B that also may be joined in accordance with the invention. Other strips or profiles, not shown, may also be joined in accordance with the invention.

A method of joining a first strip 10 to a second strip 10′, each strip including: a base having first and second spaced-apart parallel longitudinal edges; and at least one longitudinal rib upstanding from the base will now be described.

A method of joining a first strip to a second strip includes the following steps:

(1) positioning an end portion 20 of the first strip 10 over an end portion 20′ of the second strip 10′ such that: the first longitudinal edge 12 of the first strip 10 overlaps and is substantially aligned with the first longitudinal edge 12′ of the second strip 10′, and the second longitudinal edge 18 of the first strip 10 overlaps and is substantially aligned with the second longitudinal 18′ edge of the second strip 10′:

(2) cutting the overlapping end portions of the first and second strips to produce a pair of adjacent angled joining end surfaces 30, 30′;

(3) treating at least one of the pair of joining end surfaces 30, 30; and

(4) pressing the pair of joining end surfaces 30, 30′ against each other so as to create compression and holding the compression for a time period, the time period sufficient to create a bond,

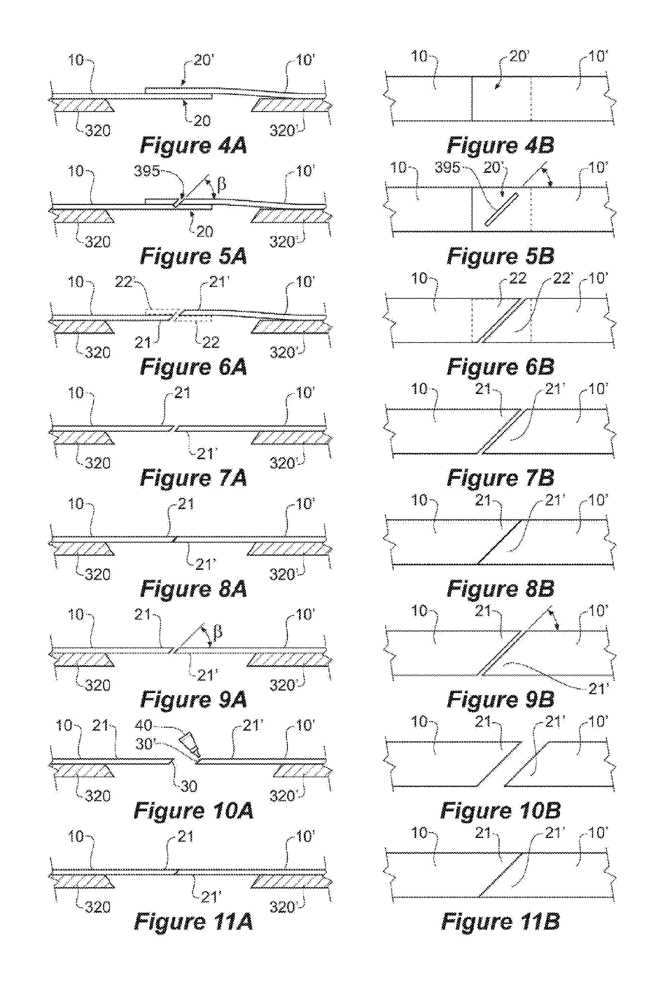

thereby bonding the first strip 10 to the second strip 10′. This method is shown progressively in FIGS. 4A and 4B through to FIGS. 11A and 11B. Specifically, step (1) above is shown in FIGS. 4A and 4B and step (2) is shown in FIGS. 5A and 5B and 6A and 6B. Step (3), the treating step, is shown in FIGS. 10A and 10B, with applicator 40 delivering an adhesive, or glue, to joining end surface 30. The pressing step (4) is illustrated in FIGS. 11A and 11B.

After the positioning step (1) above, the strips can be held in position by toggle clamps 330, 330′ as is shown in FIGS. 13A, 13C, and 13D.

With the method described above, there are a number of options for the treating step. For instance, a glue in the form of a cyanoacrylate adhesive may be used. In that case, the treating step includes applying a cyanoacrylate adhesive to one of the pair of joining end surfaces, as is illustrated in FIGS. 10A and 10B.

Another option for the treating step utilises a heating process. In that case, the treating step of FIGS. 10A and 10B includes heating both of the pair of joining end surfaces (not illustrated). Such a heating process results in welding the pair of end surfaces.

The period of time for holding the compression in step 4 above will vary, but when using a cyanoacrylate adhesive may be expected to be quite short—only a few minutes.

Additional steps of re-cutting and thereby re-forming the pair of joining end surfaces 30,30′ while the base of the first strip 10 is aligned with the base of the second strip 10′ results in the transformation of the strips as they are shown in FIGS. 8A and 8B to FIGS. 9A and 9B. This additional re-cutting step, if provided, occurs between the cutting step 2 and the treating step 3 described above. It has been found that the re-cutting step significantly improves the bond attainable between the two strips because the end joining surfaces are more accurately aligned.

Referring to FIGS. 5A and 5B, an angled cut 395 in progress is shown. The cut is angled at angle θ, as shown in FIG. 5B and at an angle β, as is shown in FIG. 5A.

The completed cut is shown in FIGS. 6A and 6B. The cut results in off cut or waste portions 22,22′ and retained end portions 21,21′. These retained end portions are now alignable, as is shown in FIGS. 7A and 7B. Once in this aligned condition, they can be brought together by movement of a floating strip support surface 320 towards a fixed strip support surface 320′, as is illustrated progressively from FIGS. 7A and 7B to FIGS. 8A and 8B.

Once in the position shown in FIGS. 8A and 8B, where rough cut ends are held substantially adjacent, a second, more precise cut can be made at angles θ and β so as to provide clean and closely aligned joining end surfaces 30 and 30′.

The floating strip support surface 320 is then moved away from the fixed strip support 320′ into the position shown in FIGS. 10A and 10B. At this point, an applicator 40 can be used to apply an adhesive to the joining end surface 30.

The floating strip support surface 320 is then moved back towards the fixed strip support surface 320′ such that the retained end portion 21 pushes against the retained end portion 21′ and the joining end surface 30 and 30′ are pressed against each other. The surfaces 30,30′ are held against each other for a minute or two until the adhesive has reached sufficient strength (the length of time required for this step will depend on the formulation of the adhesive and various other factors).

Where the treating step utilises a heating process (instead of a gluing process), the joining end surface 30 and 30′ are pressed against each other while partially melted. The surfaces 30,30′ are held against each other for a minute or two until the weld has reached sufficient strength (the length of time required for this step will depend on various factors).

The above-described method allows large spools of strip to be created from multiple (2 or more) lengths of (extruded) strip. This reduces waste and improves efficiency of creating of large capacity spools.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

Please note that the following claims are provisional claims only, and are provided as examples of possible claims and are not intended to limit the scope of what may be claimed in any future patent applications based on the present application. Integers may be added to or omitted from the example claims at a later date so as to further define or re-define the invention.

1. A strip assembly helically windable to form a pipe, the strip assembly including a pair of joined elongate strips, each strip when straight including:
a base lying in or adjacent to a base plane;
at least one longitudinal rib upstanding from the base;
a pair of spaced apart longitudinal parallel edges; and
a joining end surface,
wherein the joining end surfaces lie in a joining plane, the joining plane intersecting the base plane to form an intersecting line, the intersecting line defining an angle θ with respect to the parallel edges, the angle θ less than 80 degrees, and,
wherein the joining plane forms an angle β with respect to the base plane, the angle β being less than 75 degrees.

2. The strip assembly as claimed in claim 1 wherein the angle θ is less than 73 degrees.

3. The strip assembly as claimed in claim 1 wherein angle β is less than 65 degrees.

4. The strip assembly as claimed in claim 1 wherein the angle θ is less than 65 degrees.

5. The strip assembly as claimed in claim 1 wherein angle β is less than 55 degrees.

6. The strip assembly as claimed in claim 1 wherein the angle 9 is between 35 and 55 degrees.

7. The strip assembly as claimed in claim 1 wherein angle β is between 35 and 55 degrees.

8. The strip assembly as claimed in claim 1 wherein the pair of joined strips are joined by an adhesive.

9. The strip assembly as claimed in claim 1 wherein the adhesive is a cyanoacrylate adhesive.

10. The strip assembly as claimed in claim 1 wherein each strip includes a plurality of ribs, each rib upstanding from the base.

11. A strip assembly helically windable to form a pipe, the strip assembly including a pair of joined elongate strips, each strip having a strip width and a strip height and each strip including:
a base;
at least one longitudinal rib upstanding from the base;
a pair of spaced apart longitudinal parallel edges; and
an angled joining end surface,
whereby each joining end surface has a joining width, the joining width at least 1.5% greater than the strip width, and
whereby each joining end surface has a joining height, the joining height at least 3.5% greater than the strip height.

12. The strip assembly as claimed in claim 11 wherein, the joining width is at least 5% greater than the strip width.

13. The strip assembly as claimed in claim 11 wherein the joining height is at least 10% greater than the strip height.

14. The strip assembly as claimed in claim 11 wherein, the joining width is at least 10% greater than the strip width.

15. The strip assembly as claimed in claim 11 wherein the joining height is at least 20% greater than the strip height.

16. (canceled)

17. A method of joining a first strip to a second strip, each strip including: a base having first and second spaced-apart parallel longitudinal edges; and at least one longitudinal rib upstanding from the base, the method including the steps of:
(1) positioning an end portion of the first strip over an end portion of the second strip such that: the first longitudinal edge of the first strip overlaps and is substantially aligned with the first longitudinal edge of the second strip, and the second longitudinal edge of the first strip overlaps and is substantially aligned with the second longitudinal edge of the second strip;
(2) cutting the overlapping end portions of the first and second strips to produce a pair of adjacent angled joining end surfaces;
(3) treating at least one of the pair of joining end surfaces;
(4) pressing the pair of joining end surfaces against each other so as to create compression and holding the compression for a time period, the time period sufficient to create a bond,
thereby bonding the first strip to the second strip.

18. The method as claimed in claim 17 including the step of:
re-cutting and thereby re-forming the pair of joining end surfaces while the base of the first strip is aligned with the base of the second strip,
wherein, the re-cutting step occurring between the cutting and the treating steps.

19. The method as claimed in claim 18 including the step of:
re-positioning the relative positions of the joining end surface of the first strip and the joining end surface of the second strip such that they are aligned,
wherein, the re-positioning step occurs between the cutting and the re-cutting steps.

20. The method as claimed in claim 19 wherein the treating step includes applying a cyanoacrylate adhesive to one of the pair of joining end surfaces.

21. The method as claimed in claim 20 wherein the treating step includes heating both of the pair of joining end surfaces.
